(19) United States
(12) Patent Application Publication
(10) Pub. No.: US 2010/0214248 A1
(43) Pub. Date: Aug. 26, 2010

(54) DISPLAY APPARATUS WITH TOUCH SENSOR FUNCTION

(75) Inventors: Yasushi TAKANO, Matsumoto (JP); Hiromi SAITO, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/709,570

(22) Filed: Feb. 22, 2010

(30) Foreign Application Priority Data
Feb. 25, 2009 (JP) 2009-043224

(51) Int. Cl. G06F 3/041

(52) U.S. Cl. 345/173

(57) ABSTRACT

A display apparatus with a touch sensor function includes: a first substrate having a common electrode; a second substrate arranged to face the first substrate; a display section disposed between the first substrate and the second substrate; and a touch sensor that detects a touch position on a touch surface disposed on the side of the first substrate or on the side of the second substrate, wherein the second substrate has a plurality of data lines arranged in a row direction, a plurality of gate lines arranged in a column direction substantially perpendicular to the data lines, a plurality of pixel electrodes each arranged in a pixel region surrounded by a pair of neighboring data lines and a pair of neighboring gate lines, and a plurality of thin film transistors each arranged in the plurality of pixel electrodes and electrically connected to the pixel electrode, the data line, and the gate line, and the touch sensor has a potential increase rate detection unit that detects a potential increase rate upon charging each of the pixel regions and detects a position of the pixel region whose potential increase rate detected by the potential increase rate detection unit falls outside a predetermined range as the touch position.

### BACKGROUND

1. Technical Field

The present invention relates to a display apparatus with a touch sensor function.

2. Related Art

As a display apparatus with a touch sensor function, a configuration having an input device mounted on a liquid crystal display apparatus, such as an ATM, has been known. As an input device, a touch panel device has been known in which an input tool, such as a touch pen, or a human's finger is brought into contact with any position on a touch surface to specify the contact position, so that various kinds of operation and input of an electronic apparatus are performed. As the touch panel device described above, for example, various types of devices, such as resistive type, capacitive type, or ultrasonic surface acoustic wave type devices, have been known (for example, refer to JP-A-2009-3672).

In JP-A-2009-3672, as a display apparatus with a touch sensor function, an electro-optic apparatus having an ultrasonic surface acoustic wave type touch panel device mounted on a liquid crystal display apparatus is disclosed. In the electro-optic apparatus, since an image displayed on the liquid crystal display apparatus is visually recognized via the touch panel device, the touch panel device (portion corresponding to a screen of the liquid crystal display apparatus) is formed of a transparent member.

In the electro-optic apparatus disclosed in JP-A-2009-3672, however, when light generated from the liquid crystal display apparatus transmits through the touch panel device, each part of the touch panel device absorbs or reflects the light. Therefore, it is impossible to provide a favorable image. Moreover, in the electro-optic apparatus disclosed in JP-A-2009-3672, the configuration of mounting the touch panel device on the liquid crystal display apparatus results in an increase in the size of the apparatus.

### SUMMARY

An advantage of some aspects of the invention is to provide a display apparatus with a touch sensor function that can provide a favorable image and reduce its size by adding a touch sensor function to a display apparatus.

A first aspect of the invention is directed to a display apparatus with a touch sensor function including: a first substrate having a common electrode; a second substrate arranged to face the first substrate; a display section disposed between the first substrate and the second substrate; and a touch sensor that detects a touch position on a touch surface disposed on the side of the first substrate or on the side of the second substrate, wherein the second substrate has a plurality of data lines arranged in a row direction, a plurality of gate lines arranged in a column direction substantially perpendicular to the data lines, a plurality of pixel electrodes each arranged in a pixel region surrounded by a pair of neighboring data lines and a pair of neighboring gate lines, and a plurality of thin film transistors each arranged in the plurality of pixel electrodes and electrically connected to the pixel electrode, the data line, and the gate line, and the touch sensor has a potential increase rate detection unit that detects a potential increase rate upon charging each of the pixel regions and detects a position of the pixel region whose potential increase rate detected by the potential increase rate detection unit falls outside a predetermined range as the touch position.

This makes it possible to provide a display apparatus with a touch sensor function that can provide a favorable image and reduce its size by adding a touch sensor function to a display apparatus.

It is preferable that the potential increase rate detection unit detect the potential increase rate of each of the pixel regions via the plurality of data lines.

This makes it possible to simplify the configuration of the apparatus.

It is preferable that the touch sensor sequentially apply voltage to the plurality of gate lines, substantially simultaneously apply, in accordance with the timing of applying the voltage, voltage to the plurality of data lines to charge each of the pixel regions, and detect a potential increase rate in each of the pixel regions upon charging with the potential increase rate detection unit.

This makes it possible to correctly detect the potential increase rate of each of the pixel regions at the time of charging.

It is preferable that the application of voltage to the data lines for charging be performed during a time in which an image signal is not applied to the plurality of data lines.

This makes it possible to correctly detect the potential increase rate of each of the pixel regions at the time of charging and correctly detect a touch position on the touch surface.

It is preferable that the time in which the image signal is not applied be a blanking period.

This makes it possible to detect a touch position on the touch surface without deteriorating the quality of an image to be displayed.

It is preferable that the touch sensor detect the potential increase rates of all the pixel regions at the time of charging in a plurality of blanking periods.

This makes it possible to achieve power saving drive without decreasing the substantial accuracy of touch position detection.

It is preferable that the touch sensor detect the potential increase rates of all the pixel regions at the time of charging in one blanking period.

This improves the accuracy of touch position detection.

It is preferable that the touch sensor detect the potential increase rates of the pixel regions at the time of charging at a rate of once every plurality of blanking periods.

This makes it possible to achieve power saving drive without decreasing the substantial accuracy of touch position detection.

It is preferable that the display section has a liquid crystal layer.

This makes an image display function excellent.

### BRIEF DESCRIPTION OF THE DRAWINGS

The invention will be described with reference to the accompanying drawings, wherein like numbers reference like elements.

FIG. 1 is a cross-sectional view showing a preferred embodiment of a display apparatus with a touch sensor function of the invention.

FIG. 2 is a plan view of a TFT array substrate provided in the display apparatus with a touch sensor function shown in FIG. 1.

FIG. 3 is an enlarged perspective view of a pixel region.

FIG. 4 is a block diagram of a control unit provided in the display apparatus with a touch sensor function shown in FIG. 1.

FIG. 5 shows an equivalent circuit of a pixel region.

FIG. 6 is a block diagram of a touch sensor provided in the display apparatus with a touch sensor function shown in FIG. 1.

### DESCRIPTION OF EXEMPLARY EMBODIMENTS

Hereinafter, a display apparatus with a touch sensor function of the invention will be described in detail based on a preferred embodiment shown in the accompanying drawings.

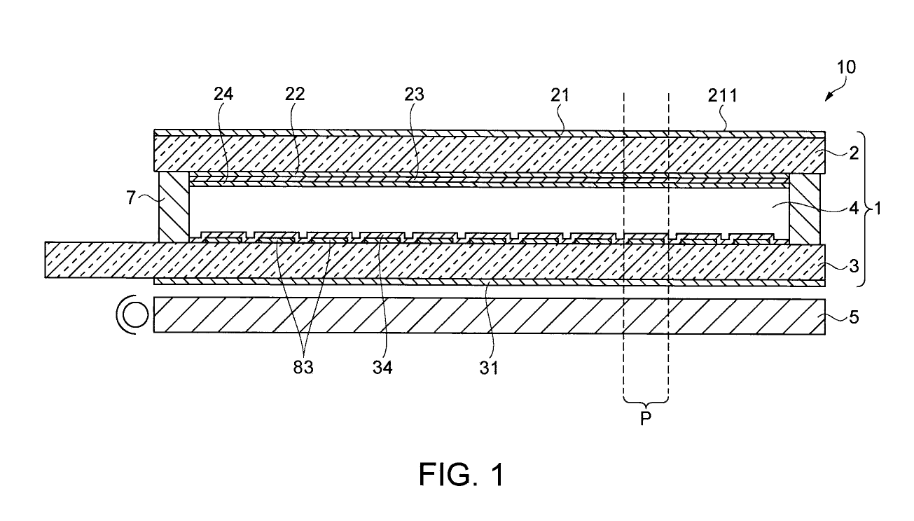

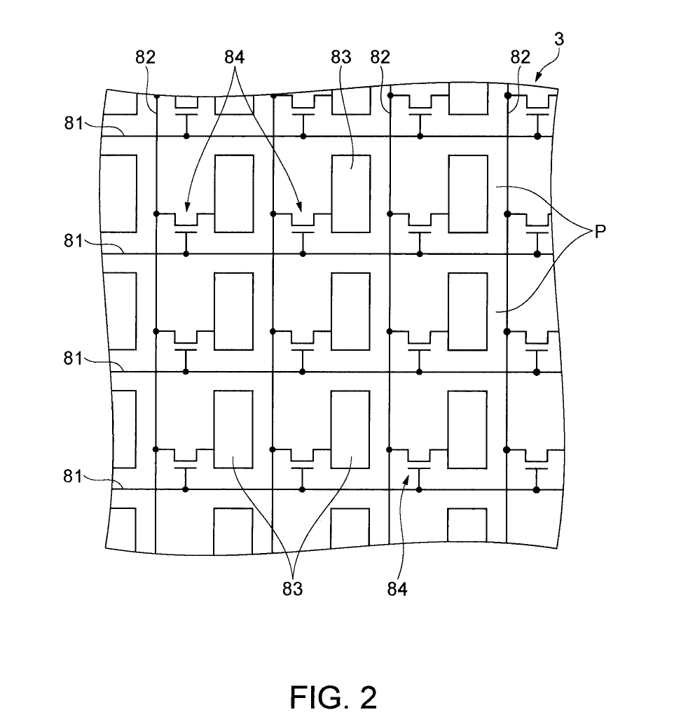

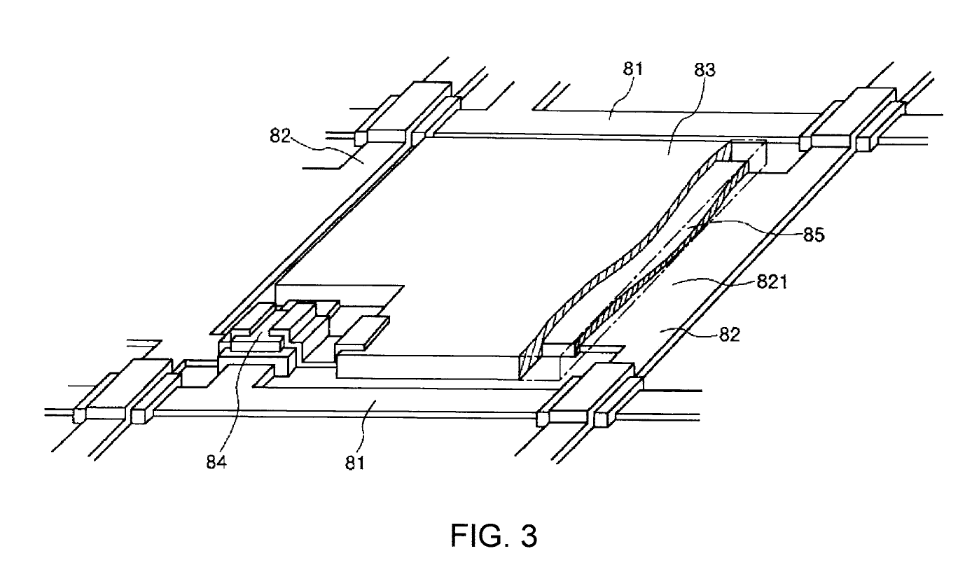

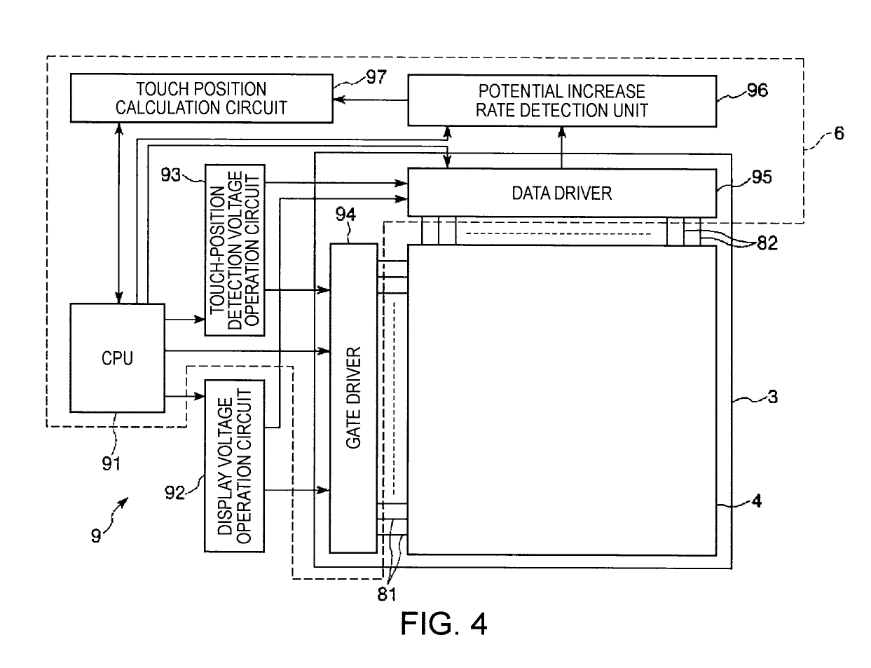

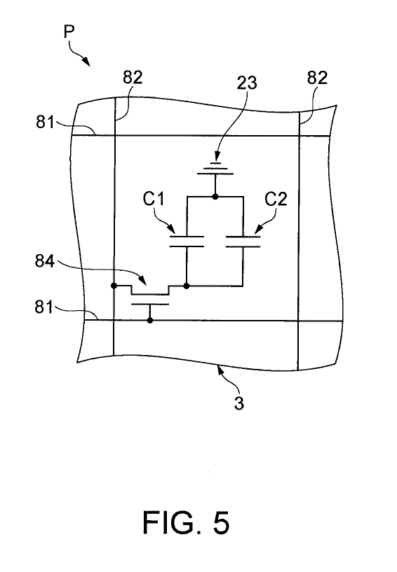

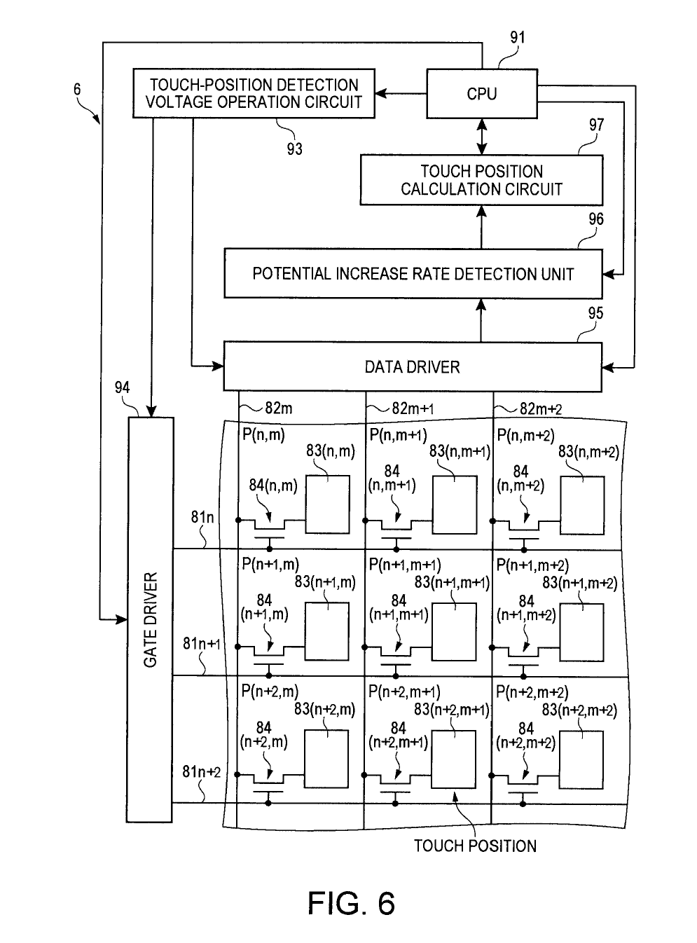

FIG. 1 is a cross-sectional view showing the preferred embodiment of the display apparatus with a touch sensor function of the invention. FIG. 2 is a plan view of a TFT array substrate provided in the display apparatus with a touch sensor function shown in FIG. 1. FIG. 3 is an enlarged perspective view of a pixel region. FIG. 4 is a block diagram of a control unit provided in the display apparatus with a touch sensor function shown in FIG. 1. FIG. 5 shows an equivalent circuit of the pixel region. FIG. 6 is a block diagram of a touch sensor provided in the display apparatus with a touch sensor function shown in FIG. 1. Here, the upper, lower, right, and left sides of FIGS. 1 to 3, 5, and 6 respectively correspond to the up, down, right, and left directions in the following description for convenience.

A liquid crystal display apparatus (display apparatus with a touch sensor function) 10 shown in FIG. 1 has a liquid crystal panel 1 including a counter substrate (first substrate) 2 and a TFT array substrate (second substrate) 3 that face each other and a liquid crystal layer (display section) 4 that is formed between the counter substrate and the TFT array substrate, and a backlight 5 that is disposed below the liquid crystal panel 1. As shown in FIG. 4, the liquid crystal display apparatus 10 also includes a control unit 9, apart of which constitutes a touch sensor 6. The touch sensor 6 can detect a touch position on an upper surface (touch surface 211) of the liquid crystal panel 1. In the liquid crystal display apparatus 10, an image corresponding to a touch position detected by the touch sensor 6 can be displayed, for example.

The backlight 5 has a function of supplying the liquid crystal panel 1 with light, and the configuration thereof is not specifically limited. For example, the backlight 5 can be configured by a square plate-shaped stacked body having a reflection plate, a light guide plate, a prism sheet (optical sheet), and a diffuser stacked in order from the bottom (opposite side from the liquid crystal panel 1) and cold cathode fluorescent tubes disposed on the side surface of the light guide plate. Instead of the cold cathode fluorescent tubes, LEDs or the like may be used.

The liquid crystal panel 1 that is irradiated with light from the backlight 5 is disposed above the backlight 5. The counter substrate 2 and the TFT array substrate 3 provided in the liquid crystal panel 1 are both a colorless, transparent glass substrate having a square plate shape. These substrates are bonded together with a square frame-shaped seal member 7 disposed along the peripheral portion of the counter substrate 2. A liquid crystal material is filled in a space defined by the counter substrate 2, the TFT array substrate 3, and the seal member 7, whereby the liquid crystal layer 4 is formed. The liquid crystal layer 4 described above is used as a display section, so that the liquid crystal display apparatus 10 can exert an excellent image display function.

An optical substrate 31 formed of a polarizer, a retardation film, and the like is bonded to the lower surface (surface on the side of the backlight 5) of the TFT array substrate 3. The optical substrate 31 has a function of making light from the backlight 5 into linearly polarized light and emitting the light to the liquid crystal layer 4.

As shown in FIG. 2, on the other hand, a plurality of gate lines 81, data lines 82, pixel electrodes 83, and TFTs (thin film transistors) 84 are formed on the upper surface (surface on the side of the liquid crystal layer 4) of the TFT array substrate 3.

The plurality of gate lines 81 are formed in the vertical direction (column direction) in FIG. 2 at an equal pitch and each extend in the horizontal direction (row direction) in FIG. 2. Each of the gate lines 81 is electrically connected to a gate driver 94 formed at the edge portion (portion projecting leftward in FIG. 2 from the liquid crystal layer 4) of the TFT array substrate 3.

The plurality of data lines 82 are formed in the horizontal direction (row direction) in FIG. 2 at an equal pitch and each extend in the vertical direction (column direction) in FIG. 2. Each of the data lines 82 is electrically connected to a data driver 95 formed at the edge portion (portion projecting upward in FIG. 2 from the liquid crystal layer 4) of the TFT array substrate 3.

The pixel electrode 83 and the TFT 84 are formed in each of a plurality of pixel regions (pixels) P surrounded by a pair of neighboring gate lines 81 and 81 and a pair of neighboring data lines 82 and 82.

FIG. 3 is an enlarged view of one pixel region P. As shown in FIG. 3, the TFT 84 is disposed near the crossing portion of the gate line 81 and the data line 82, in which a source electrode, a gate electrode, and a drain electrode are electrically connected to the gate line 81, the data line 82, and the pixel electrode 83, respectively. The pixel electrode 83 is formed over the wide area of the pixel region P except for a region where the TFT 84 is formed. The pixel electrode 83 is formed of a transparent conductive film and is light transmissive.

As shown in FIG. 3, the pixel region P is provided with a storage capacitance electrode 821 formed by projecting a part of the data line 82 positioned on the right side of the pixel region P. The storage capacitance electrode 821 and the pixel electrode 83 face each other via an insulating film 85, whereby a storage capacitance capacitor is formed.

As shown in FIG. 1, an alignment film 34 subjected to an alignment treatment is formed on the thus configured pixel regions P. The alignment film 34 is formed of a high molecular material having an alignment property, such as polyimide having an alignment property. The alignment film 34 sets the alignment of liquid crystal molecules to a predetermined direction near the corresponding pixel electrode 83.

A polarizer 21 that emits linearly polarized light perpendicular to light from the optical substrate 31 outward (upward in FIG. 1) is bonded to the upper surface of the counter substrate 2 that faces the TFT array substrate 3 described above via the liquid crystal layer 4. The upper surface (surface exposed to the outside of the apparatus) of the polarizer 21 constitutes the touch surface 211 touched by an input tool, such as a touch pen, or an operator's finger.

On the other hand, a color filter 22 is formed on the lower surface of the counter substrate 2. A common electrode 23 is formed below the color filter. In the same manner as the pixel electrode 83, the common electrode 23 is formed of a transparent conductive film and is light transmissive. The common electrode 23 is grounded. An alignment film 24 subjected to an alignment treatment is formed below the common electrode 23. The alignment film 24 sets the alignment of liquid crystal molecules to a predetermined direction near the common electrode 23.

Next, the control unit 9 that controls driving of the liquid crystal display apparatus 10 will be described.

As shown in FIG. 4, the control unit 9 has a CPU 91, a display voltage operation circuit 92, a touch-position detection voltage operation circuit 93, the gate driver 94, the data driver 95, a potential increase rate detection unit 96, and a touch position calculation circuit 97. Among them, the CPU 91, the display voltage operation circuit 92, the gate driver 94, and the data driver 95 display a desired image in the liquid crystal display apparatus 10. The CPU 91, the touch-position detection voltage operation circuit 93, the gate driver 94, the data driver 95, the potential increase rate detection unit 96, and the touch position calculation circuit 97 detect a touch position on the touch surface 211. That is, the CPU 91, the touch-position detection voltage operation circuit 93, the gate driver 94, the data driver 95, the potential increase rate detection unit 96, and the touch position calculation circuit 97 constitute the touch sensor 6.

First, display of an image by the control unit 9 will be described.

The CPU 91 forms a timing signal, a data signal for display, a control signal, and the like necessary for the display voltage operation circuit 92, the gate driver 94, and the data driver 95. The display voltage operation circuit 92 that has received a signal from the CPU 91 forms a plurality of voltage levels (voltage levels to be applied to the pixel electrodes 83) necessary for displaying a desired image in the liquid crystal display apparatus 10.

The gate driver 94 sequentially applies voltage to the plurality of gate lines 81 one by one (for example, from the gate line 81 at the uppermost side of FIG. 2 in order) at a predetermined timing based on a signal from the display voltage operation circuit 92, a timing signal from the CPU 91, or the like. This brings the TFTs 84 connected to the gate line 81 to which the voltage is applied into an ON state.

The data driver 95 applies voltage to each of the data lines 82 in accordance with the timing at which the voltage is applied to the gate line 81 based on a data signal for display (voltage level to be applied to each of the pixel electrodes 83) from the display voltage operation circuit 92, a timing signal from the CPU 91, or the like. The data driver 95 sequentially performs the voltage application described above on all the date lines 82 to apply voltage to all the pixel electrodes 83.

In each of the pixel regions P, when the voltage is applied to the pixel electrode 83, liquid crystal is driven according to the voltage level. With this driving, when the light from the backlight 5 passes through the liquid crystal layer 4, the polarized light state of the light can be modulated in each of the pixel regions P. As a result, a desired image is displayed on the touch surface 211 by the light having passed through the liquid crystal layer 4.

Next, the detection of touch position on the touch surface 211 by the control unit 9 (the touch sensor 6) will be described.

The CPU 91 forms a timing signal, a signal for charge, a control signal, and the like necessary for the touch-position detection voltage operation circuit 93, the gate driver 94, the data driver 95, the potential increase rate detection unit 96, and the touch position calculation circuit 97. The touch-position detection voltage operation circuit 93 that has received a signal from the CPU 91 forms voltage levels (voltage levels to be applied to the pixel electrodes 83) necessary for charging the pixel regions P. The voltage levels to be applied to the pixel electrodes 83 are preferably equal to one another.

The gate driver 94 sequentially applies voltage to the plurality of gate lines 81 one by one at a predetermined timing based on a signal from the touch-position detection voltage operation circuit 93, a timing signal from the CPU 91, or the like.

The data driver 95 applies an identical level voltage (charge signal voltage) to each of the data lines 82 in accordance with the timing at which voltage is applied to the gate line 81 based on a signal (charge signal for charging each of the pixel regions P) from the touch-position detection voltage operation circuit 93, a timing signal from the CPU 91, or the like to charge the pixel regions P corresponding to the gate line 81 to which the voltage is applied. The data driver 95 sequentially performs the voltage application described above on all the date lines 82 to charge all the pixel regions P. According to the charging method described above, it is possible to easily and reliably charge all the pixel regions P. Moreover, since the charging method is similar to a driving method when displaying an image, the control is easy.

The potential increase rate detection unit 96 detects the potential increase rate of each of the pixel regions P at the time of charging via the data line 82 and transmits the detection result to the touch position calculation circuit 97. Since the potential increase rate of each of the pixel regions P is detected by using the data line 82, that is, since the data line 82 functions both as a wire for image display and a wire for charge, the configuration of the apparatus can be simplified.

FIG. 5 is an equivalent circuit of one pixel region P. In FIG. 5, “C1” denotes a pixel capacitance formed by interposing the liquid crystal layer 4 between the pixel electrode 83 and the common electrode 23, while “C2” denotes a storage capacitance formed by interposing the insulating film 85 between the storage capacitance electrode 821 and the pixel electrode 83. In the pixel region P corresponding to a touch position on the touch surface 211, pressing the touch surface 211 by a finger, an input tool, or the like decreases the gap between the common electrode 23 and the pixel electrode 83 compared with a state where the touch surface 211 is not pressed, so that the pixel capacitance C1 is changed (increased), or touching the touch surface 211 by a finger generates a stray capacitance, so that the entire capacitance of the pixel region P is changed. Therefore, the potential increase rate upon charging the pixel region P is changed (decreased). That is, the potential increase rate of the pixel region P corresponding to a touch position on the touch surface 211 at the time of charging is different from the potential increase rate of the other pixel regions P at the time of charging.

By utilizing the above-described characteristics (change in potential increase rate), the touch position calculation circuit 97 detects a position (position on the touch surface 211 as viewed in a plane) of the pixel region P whose potential increase rate falls outside a predetermined range T as a touch position. The “predetermined range T” can be set, with the potential increase rate of the pixel region P that is not touched at the time of charging being as a reference for example, as a range including a predetermined width below and above (decreasing and increasing directions) of the reference.

Description will be made below specifically based on FIG. 6.

Hereinafter, the plurality of gate lines 81 are defined as a “gate line 81ₙ”, a “gate line 81ₙ₊₁”, and a “gate line 81ₙ₊₂” from the upper side of FIG. 6 in order, while the plurality of data lines 82 are defined as a “data line 82ₘ”, a “data line 82₊₁”, and a “data line 82ₘ₊₂” from the left side of FIG. 6 in order. Moreover, the pixel region P, the pixel electrode 83, and the TFT 84 corresponding to the gate line 81ₙ and the data line 82ₘ are defined as a “pixel region P_{(n, m)}”, a “pixel electrode 83_{(n, m)}”, and a “TFT 84_{(n, m)}”, respectively. The same applies to the other pixel regions P, pixel electrodes 83, and TFTs 84. Also in this case, description will be made on the case where a position corresponding to a pixel region P_{(n+2, m+1)} of the touch surface 211 is touched. That is, only the potential increase rate of the pixel region P_{(n+2, m+1)} at the time of charging falls outside the predetermined range T set in the touch position calculation circuit 97.

### 1. Gate Line 81ₙ

First, the gate driver 94 applies voltage to the gate line 81ₙ to bring the TFT 84_{(n, m)}, a TFT 84_{(n, m+1)}, and a TFT 84_{(n, m+2)} connected to the gate line 81ₙ into the ON state. In this case, TFTs 84_{(n+1, m)} to 84_{(n+1, m+2)} connected to the gate line 81ₙ₊₁ and TFTs 84_{(n+2, m)} to 84_{(n+2, m+2)} connected to the gate line 81ₙ₊₂ are in the OFF state.

Next, in accordance with the application of voltage to the gate line 81ₙ (that is, when voltage is being applied to the gate line 81ₙ), the data driver 95 applies an identical level voltage (charge signal) to the data lines 82ₘ to 82ₘ₊₂.

When the voltage (charge signal) is applied to the data lines 82ₘ to 82ₘ₊₂, the voltage (charge signal) is applied to the pixel electrodes 83_{(n, m)} to 83_{(n, m+2)} corresponding to the TFTs 84_{(n, m)} to 84_{(n, m+2)} in the ON state, so that the charge of the pixel regions P_{(n, m)} to P_{(n, m+2)} is started. When the charge of the pixel regions P_{(n, m)} to P_{(n, m+2)} is started, the potential increase rate detection unit 96 detects the potential increase rate in each of the pixel regions P_{(n, m)} to P_{(n, m+2)} and transmits the detection result to the touch position calculation circuit 97.

The touch position calculation circuit 97 compares the received potential increase rates of the pixel region P_{(n, m)} to the pixel region P_{(n, m+2)} with the set predetermined range T. Since positions corresponding to the pixel regions P_{n, m)} to P_{(n, m+2)} of the touch surface 211 are not touched, the potential increase rates of the pixel region P_{n, m)} to the pixel region P_{(n, m+2)} fall within the predetermined range T. With this comparison, the touch position calculation circuit 97 determines that the positions corresponding to the pixel regions P_{(n, m)} to P_{(n, m+2)} of the touch surface 211 are not touched.

### 2. Gate Line 81_{n30 1}

Next, the gate driver 94 applies voltage to the gate line 81ₙ₊₁ to bring the TFT 84_{(n+1, m)}, the TFT 84_{(n+1, m+1)}, and the TFT 84_{(n+1, m+2)} connected to the gate line 81ₙ₊₁ into the ON state. In this case, the TFTs 84_{(n, m)} to 84_{(n, m+2)} connected to the gate line 81ₙ and the TFTs 84_{n+2, m)} to 84_{(n+2, m+2)} connected to the gate line 81ₙ₊₂ are in the OFF state.

Next, in accordance with the application of voltage to the gate line 81ₙ₊₁, the data driver 95 applies an identical level voltage (charge signal) to the data lines 82ₘ to 82ₘ₊₂. The voltage level is preferably the same as the voltage applied to the data lines 82ₘ to 82ₘ₊₂ in 1 described above.

When the voltage is applied to the data lines 82ₘ to 82ₘ₊₂, voltage is applied to the pixel electrodes 83_{(n+1, m)} to 83_{(n+1, m+2)} corresponding to the TFTs 84_{(n+1, m)} to 84_{(n+1, m+2)} in the ON state to start the charge of the pixel regions P_{(n+1, m)} to P_{(n+1, m+2)}. When the charge of the pixel regions P_{(n+1, m)} to P_{(n+1, m+2)} is started, the potential increase rate detection unit 96 detects the potential increase rate in each of the pixel regions P_{(n+1, m)} to P_{(n+1, m+2)}, and transmits the detection result to the touch position calculation circuit 97.

The touch position calculation circuit 97 compares the received potential increase rates of the pixel region P_{(n+1, m)} to the pixel region P_{(n+1, m+2)} with the set predetermined range T. Since positions corresponding to the pixel regions P_{(n+1, m)} to P_{(n+1, n+2)} of the touch surface 211 are not touched, the potential increase rates of the pixel regions P_{(n+1, m)} to P_{(n+1, m+2)} fall within the predetermined range T. With this comparison, the touch position calculation circuit 97 determines that the positions corresponding to the pixel regions P_{(n+1, m)} to P_{(n+1, m+2)} of the touch surface 211 are not touched.

3. Gate Line 81ₙ₊₂

Next, the gate driver 94 applies voltage to the gate lines 81ₙ₊₂ to bring the TFT 84_{(n+2, m)}, the TFT 84_{(n+2, m+1)}, and the TFT 84_{(n+2, m+2)} connected to the gate line 81ₙ₊₂ into the ON state. In this case, the TFTs 84_{(n, m)} to 84_{(n, m+2)} connected to the gate line 81ₙ and the TFTs 84_{(n+1, m)} to 84_{(n+1, m+2)} connected to the gate line 81ₙ₊₁ are in the OFF state.

Next, in accordance with the application of voltage to the gate line 81ₙ₊₂, the data driver 95 applies an identical level voltage (charge signal) to the data lines 82ₘ to 82ₘ₊₂. The voltage level is preferably the same as the voltage applied to the data lines 82ₘ to 82ₘ₊₂ in 1 described above.

When the voltage is applied to the data lines 82ₘ to 82ₘ₊₂, voltage is applied to the pixel electrodes 83_{(n+2, m)} to 83_{(n+2, m+2)} corresponding to the TFTs 84_{(n+2, m)} to 84_{(n+2, m+2)} in the ON state to start the charge of the pixel regions P_{(n+2, m)} to P_{(n+2, m+2)}. When the charge of the pixel regions P_{(n+2, m)} to P_{(n+2, m+2)} is started, the potential increase rate detection unit 96 detects the potential increase rate in each of the pixel regions P_{(n+2, m)} to P_{(n+2, m+2)} and transmits the detection result to the touch position calculation circuit 97.

The touch position calculation circuit 97 compares the received potential increase rates of the pixel region P_{(n+2, m)} to the pixel region P_{(n+2, m+2)} with the set predetermined range T. Since positions corresponding to the pixel regions P_{(n+2, m)} and P_{(n+2, m+2)} of the touch surface 211 are not touched, the potential increase rates of the pixel regions P_{(n+2, m)} and P_{(n+2, m+2)} fall within the predetermined range T. With this comparison, the touch position calculation circuit 97 determines that the positions corresponding to the pixel regions P_{(n+2, m)} and P_{(n+2, m+2)} of the touch surface 211 are not touched.

On the other hand, since a position corresponding to the pixel region P_{(n+2, m+1)} of the touch surface 211 is touched, the potential increase rate of the pixel region P_{(n+2, m+1)} at the time of charging falls outside the predetermined range T. With this comparison, the touch position calculation circuit 97 determines that the position corresponding to the pixel region P_{(n+2, m+1)} of the touch surface 211 is touched (that is, a touch position).

As described above, the touch position calculation circuit 97 compares the potential increase rates of all the pixel regions P at the time of charging with the predetermined range T to determine whether or not the touch surface 211 corresponding to the region is touched in each of the pixel regions P, thereby detecting a touch position on the touch surface 211. Then, the touch position calculation circuit 97 transmits the detection result (touch position information) to the CPU 91.

The CPU 91 that has received the touch position information forms a data signal for display corresponding to the position information and transmits the formed data signal for display, together with a timing signal, a control signal, and the like, to portions of the display voltage operation circuit 92, the gate driver 94, and the data driver 95 that require the signals. This causes an image corresponding to a touch position to be displayed on the touch surface 211.

The method for detecting a touch position by the touch sensor 6 has been described in detail.

According to the touch sensor 6 described above, even when two or more positions are simultaneously touched on the touch surface 211 for example, all touch positions can be detected. That is, the touch sensor 6 can support multi-touch, so that the convenience of the liquid crystal display apparatus 10 provided with the touch sensor 6 can be improved.

It is preferable that the detection of touch position by the touch sensor 6 be performed during a period in which voltage (data signal for display) for displaying an image is not applied to the data line 82. This makes it possible to correctly detect the potential increase rate of each of the pixel regions at the time of charging and correctly detect a touch position on the touch surface 211.

It is especially preferable that the detection of touch position by the touch sensor 6 be performed during a blanking period in the period described above. This makes it possible to detect a touch position on the touch surface 211 without deteriorating the quality of an image displayed on the touch surface. The “blanking period” as used herein means a period from when the display of a predetermined image (frame) is finished until the display of a next image (frame) is started. In other words, in the case where voltage is applied from the gate line 81, positioned on the upper side of FIG. 6 to the lower side in order, the blanking period means a period from when the application of voltage to the gate line 81ₙ₊₂ is finished until the application of voltage to the gate line 81ₙ is started.

The touch sensor 6 may perform the detection of touch position on the touch surface 211 in all blanking periods or may perform at a rate (cycle) of once every plurality of periods (for example, once every 60 periods).

When the detection of touch position on the touch surface 211 is performed in all the blanking periods, even the touch position of high-speed touch (touch whose contact time with the touch surface 211 is short) can be detected, which provides an advantage that the accuracy of touch position detection is improved.

On the other hand, when the detection of touch position on the touch surface 211 is performed at a rate of once every plurality of blanking periods, there is an advantage that the power saving drive of the liquid crystal display apparatus 10 can be achieved. In a general liquid crystal display apparatus, since an image displayed on the touch surface 211 has about 60 frames per second, there also are 60 blanking periods per second. However, the time in which the touch surface 211 is being touched upon touching the touch surface 211 is longer than the cycle (for example, 1/60 second) of the blanking period. Therefore, even when the detection of touch position is performed at a rate of once every plurality of blanking periods, the accuracy of touch position detection is not substantially decreased.

Moreover, the detection of touch position in the entire area of the touch surface 211 may be performed in one blanking period or may be performed in a plurality of blanking periods. That is, the presence or absence of touch in all the pixel regions P may be determined in one blanking period or may be determined in a plurality of blanking periods (in FIG. 6 for example, the presence or absence of touch in the pixel regions P_{(n, m)} to P_{(n, m+2)} is determined in the first blanking period, the presence or absence of touch in the pixel regions P_{(n+1, m)} to P_{(n+1, m+2)} is determined in the second blanking period, and the presence or absence of touch in the pixel regions P_{(n+2, m)} to P_{(n+1, m+2)} is determined in the third blanking period).

When the detection of touch position in the entire area of the touch surface 211 is performed in one blanking period, even the touch position of high-speed touch (touch whose contact time with the touch surface 211 is short) can be detected, which provides an advantage that the accuracy of touch position detection is improved.

On the other hand, when the detection of touch position in the entire area of the touch surface 211 is performed in a plurality of blanking periods, the power saving drive of the liquid crystal display apparatus 10 can be achieved. In the same manner as described above, even when the detection of touch position in the entire area of the touch surface 211 is performed in a plurality of blanking periods, the accuracy of touch position detection is not substantially decreased.

According to the thus configured liquid crystal display apparatus 10, since the touch sensor 6 is incorporated therein, it is not necessary to separately mount a touch sensor on the upper side of the apparatus (display surface side). Therefore, the liquid crystal display apparatus 10 can provide a favorable image and reduce its size.

Although the display apparatus with a touch sensor function of the invention has been described based on the embodiment shown in the drawings, the invention is not limited thereto. The configuration of each part may be replaced by any configuration having the same function. Moreover, any other components or steps may be added.

The entire disclosure of Japanese Patent Application No. 2009-043224, filed Feb. 25, 2009 is expressly incorporated by reference herein.

What is claimed is:

1. A display apparatus with a touch sensor function comprising:
a first substrate having a common electrode;
a second substrate arranged to face the first substrate;
a display section disposed between the first substrate and the second substrate; and
a touch sensor that detects a touch position on a touch surface disposed on the side of the first substrate or on the side of the second substrate, wherein
the second substrate has a plurality of data lines arranged in a row direction,
a plurality of gate lines arranged in a column direction substantially perpendicular to the data lines,
a plurality of pixel electrodes each arranged in a pixel region surrounded by a pair of neighboring data lines and a pair of neighboring gate lines, and
a plurality of thin film transistors each arranged in the plurality of pixel electrodes and electrically connected to the pixel electrode, the data line, and the gate line, and
the touch sensor has a potential increase rate detection unit that detects a potential increase rate upon charging each of the pixel regions and detects a position of the pixel region whose potential increase rate detected by the potential increase rate detection unit falls outside a predetermined range as the touch position.

2. The display apparatus with a touch sensor function according to claim 1, wherein the potential increase rate detection unit detects the potential increase rate of each of the pixel regions via the plurality of data lines.

3. The display apparatus with a touch sensor function according to claim 1, wherein the touch sensor sequentially applies voltage to the plurality of gate lines, substantially simultaneously applies, in accordance with the timing of applying the voltage, voltage to the plurality of data lines to charge each of the pixel regions, and detects a potential increase rate upon charging in each of the pixel regions with the potential increase rate detection unit.

4. The display apparatus with a touch sensor function according to claim 3, wherein the application of voltage to the data lines for charging is performed during a time in which an image signal is not applied to the plurality of data lines.

5. The display apparatus with a touch sensor function according to claim 4, wherein the time in which the image signal is not applied is a blanking period.

6. The display apparatus with a touch sensor function according to claim 5, wherein the touch sensor detects the potential increase rates of all the pixel regions at the time of charging in a plurality of blanking periods.

7. The display apparatus with a touch sensor function according to claim 5, wherein the touch sensor detects the potential increase rates of all the pixel regions at the time of charging in one blanking period.

8. The display apparatus with a touch sensor function according to claim 5, wherein the touch sensor detects the potential increase rates of the pixel regions at the time of charging at a rate of once every plurality of blanking periods.

9. The display apparatus with a touch sensor function according to claim 1, wherein the display section has a liquid crystal layer.
